(19) United States
(12) Patent Application Publication
(10) Pub. No.: US 2026/0061768 A1
(43) Pub. Date: Mar. 5, 2026

(54) RECORDING APPARATUS AND RECORDING METHOD

(71) Applicant: CANON KABUSHIKI KAISHA, Tokyo (JP)

(72) Inventor: KAZUKI NARUMI, Tokyo (JP)

(21) Appl. No.: 19/306,204

(22) Filed: Aug. 21, 2025

(30) Foreign Application Priority Data
Aug. 28, 2024 (JP) 2024-146371

(51) Int. Cl. B41J 29/38; B41J 2/165; B41J 2/21; B41J 11/00

(52) U.S. Cl. CPC B41J 29/38; B41J 2/16523; B41J 2/16532; B41J 2/16535; B41J 2/2114; B41J 11/00222; B41J 11/007

(57) ABSTRACT

A recording apparatus alternately performs main scan for ejecting an ink to the recording medium and sub scan for conveying a prescribed conveyance amount of the recording medium by a conveyance unit. When a predetermined interruption operation is performed between first main scan and subsequent second main scan, the prescribed conveyance amount is conveyed by a small conveyance operation including a first small conveyance operation and a second small conveyance operation by the conveyance unit, and the conveyance amounts of the first small conveyance operation and the second small conveyance operation is determined on the basis of the gaps in a second direction of a plurality of air outlet ports so that a part of the recording medium facing the air outlet port after performing the first small conveyance operation may not be positioned at a position facing the air outlet port after performing the second small conveyance operation.

### BACKGROUND

### Field of the Technology

The present disclosure relates to an inkjet system recording apparatus and recording method.

### Description of the Related Art

In an inkjet system recording apparatus, when recording is performed on a recording medium having low ink absorption property such as a polyvinyl chloride sheet, ink droplets may be present still in a liquid state long on the recording medium, and may cause image defects such as ink flow on the recording medium. For this reason, there is a recording apparatus having a drying device that promotes evaporation of water or a solvent (liquid component) such as a flux, of ink droplets on a recording medium by blowing, heating, or the like, and efficiently fixes a coloring material on the surface of the recording medium.

With the inkjet system recording apparatus, recording is performed by repeating main scan in which ink is ejected while moving a recording head relative to a recording medium and sub scan in which the recording medium is conveyed in a direction crossing the main scanning direction. With the recording head of an inkjet recording apparatus, a mist is deposited to the periphery of the nozzle, thereby reducing the ink ejection characteristics. For this reason, when the recording time becomes longer, maintenance operations such as wiping (sweeping) and suction are required to be performed during recording (during the period between the first main scan and the subsequent second main scan). When an interruption operation such as a maintenance operation is performed during recording, the recording medium may be thermally damaged due to long-time stop of conveyance of the recording medium, and long-time retention of the recording medium in the drying device. Japanese Patent Application Publication No. 2018-130900 describes a technique of shortening the retention time of a recording medium in a drying device by conveying the recording medium in a direction from the inlet to the outlet of the drying device when an interruption operation such as a maintenance operation occurs.

As a method for enhancing the drying efficiency by the drying device, it is conceivable to increase the heating temperature. However, an increase in the heating temperature undesirably causes the recording medium to be subjected to thermal damage such as expansion and contraction, and increases power consumption. Accordingly, as another method for increasing the drying efficiency, it is conceivable to dry the recording medium using a collision jet stream blowing a jet stream of a gas onto the recording medium.

### SUMMARY

Drying of the recording medium using a collision jet stream may allow image unevenness such as a difference in luster to be visually recognized. In particular, when the conveyance is stopped for a long time by performing the interruption operation during recording, image unevenness tends to occur.

The present disclosure is directed to suppress the occurrence of image unevenness when an interruption operation is performed during recording with a recording apparatus including a drying device that dries the ink ejected to a recording medium using a collision jet stream.

A recording apparatus according to the present disclosure includes the following:
a recording head for ejecting ink while moving relative to a recording medium in a first direction;
a conveyance unit for conveying the recording medium in a second direction that intersects the first direction;
a drying unit having a plurality of air outlet ports arranged in the second direction, the drying unit spraying a jet stream of a gas from the air outlet ports toward a surface of the recording medium on which the ink has been ejected; and
a control unit for alternately performing main scan in which the recording head ejects the ink onto the recording medium and sub scan in which the conveyance unit conveys a prescribed conveyance amount of the recording medium,
wherein in a case where a predetermined interruption operation is performed between first main scan and subsequent second main scan, the control unit conveys the prescribed conveyance amount of the recording medium by a small conveyance operation including a first small conveyance operation and a subsequent second small conveyance operation by the conveyance unit, and
wherein conveyance amounts of the first small conveyance operation and the second small conveyance operation are determined on the basis of gaps in the second direction of the plurality of air outlet ports so that a part of the recording medium facing the air outlet port after performing the first small conveyance operation may not be positioned at a position facing the air outlet port after performing the second small conveyance operation.

Features of the present disclosure will become apparent from the following description of embodiments with reference to the attached drawings. The following description of embodiments is described by way of example.

### BRIEF DESCRIPTION OF THE DRAWINGS

FIG. 1 is a view illustrating an internal configuration of a recording apparatus of Example;

FIG. 2 is a view illustrating a configuration of a heating and drying mechanism of a recording apparatus of Example;

FIG. 3 is a view illustrating a configuration of a recording head of a recording apparatus of Example;

FIG. 4 is a view illustrating a maintenance mechanism of a recording apparatus of Example;

FIG. 5 is a flowchart showing the wiping operation sequence of Example;

FIG. 6 is a block diagram illustrating a functional configuration of a recording apparatus of Example;

FIG. 7 is a block diagram illustrating a functional configuration of a recording control portion of a recording apparatus of Example;

FIG. 8A is a diagram showing recording DUTY of a unit pixel;

FIG. 8B is a diagram showing generated binary image data;

FIG. 8C is a diagram showing an example of a mask pattern for use in four-pass multi-pass recording in which an image is recorded by four recording scans;

FIG. 8D is a diagram showing the positions of the dots recorded in each recording scan;

FIG. 9A is a view showing the jet stream portion of the heating and drying mechanism as viewed in the Z direction;

FIG. 9B is a view showing how the ink film ejected to the recording medium during the recording operation by the recording head enters immediately under the jet stream portion in the heating and drying mechanism in accordance with conveyance of the ink film by sub scan;

FIG. 9C is a view showing a situation in which a collision jet stream is applied to the ink film on the recording medium to cause non-uniformity in distribution of ink components in the ink film due to a difference in evaporation rate;

FIG. 10 is a view for illustrating image unevenness due to drying using a collision jet stream;

FIG. 11A is a diagram for illustrating the conveyance control at the time of the interruption operation of Example 1;

FIG. 11B is a diagram for explaining the conveyance control at the time of the interruption operation of Example 1;

FIG. 12 is a view for illustrating a conveyance control pattern in which image unevenness cannot be suppressed;

FIG. 13 is a flowchart illustrating conveyance control at the time of the interruption operation of Example 1;

FIG. 14A is a view showing a configuration of the jet stream portion of the heating and drying mechanism of Example 2;

FIG. 14B is a view showing conveyance control of Example 2; and

FIG. 15 is a view for illustrating the conveyance control at the time of the interruption operation in another Example.

### DESCRIPTION OF THE EMBODIMENTS

### Example 1

Below, one example for carrying out the present disclosure will be described with reference to the accompanying drawings. However, the dimensions, materials, shapes, relative arrangement, and the like of the constituent components described in the following Examples should be modified as appropriate depending on the configuration and various conditions of the device to which the present invention is applied, and are not intended to limit the scope of the present disclosure to the following Examples.

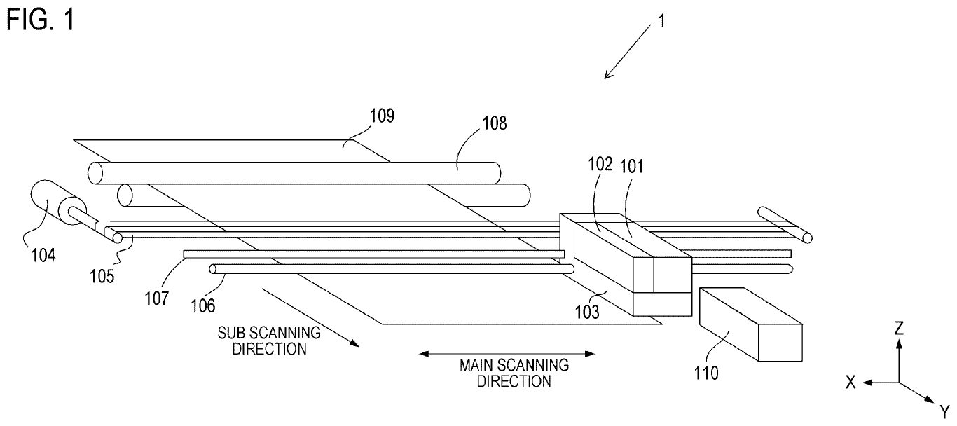

FIG. 1 is a diagram showing the internal configuration of an inkjet system recording apparatus 1 of Example 1. A drive belt 105 moves using a carriage motor 104 (hereinafter also referred to as a CR motor) as a drive source. As the drive belt 105 moves, the carriage 103 mounting recording heads 101 and 102 thereon moves back and forth in the main scanning direction (first direction, X direction) while being guided and supported by a guide shaft 106. The recording heads 101 and 102 eject an ink while relatively moving in the X direction with respect to a recording medium 109.

A flexible cable 107 electrically connects the recording heads 101 and 102 to a control substrate (not shown) provided on the apparatus main body of the recording apparatus 1 while following the movement of the carriage 103. The conveyance roller pair 108 is a conveyance unit of interposing a recording medium 109, and conveying the recording medium 109 in a second direction (sub-scanning direction, Y direction) crossing a first direction (main scanning direction, X direction).

The recording apparatus 1 records an image corresponding to the recording data on the recording medium 109 stepwise by repeating main scan and sub scan alternately. The main scan is an operation in which the carriage 103 moves in the main scanning direction while the recording heads 101 and 102 eject an ink in accordance with the recording data. The sub scan is an operation of performing conveyance of a predetermined conveyance amount of the recording medium 109 by the conveyance roller pair 108 between the first main scan and the subsequent second main scan.

At one end of the moving range in the X direction of the carriage 103, a maintenance mechanism 110 is provided which performs a maintenance operation (recovery processing) for maintaining the ejection function of the recording heads 101 and 102 in a good condition. The recovery processing includes a suction operation, a wiping operation, and a preliminary ejection operation. In the suction operation, bubbles and impurities inside the recording heads 101 and 102 are removed by forcibly sucking an ink from the nozzles (outlet ports) of the recording heads 101 and 102. In the wiping operation, the droplets on the ink ejection surfaces of the recording heads 101 and 102 are wiped. In the preliminary ejection operation, preliminary ink ejection is performed in order to adjust the ejection prior to actual recording data recording.

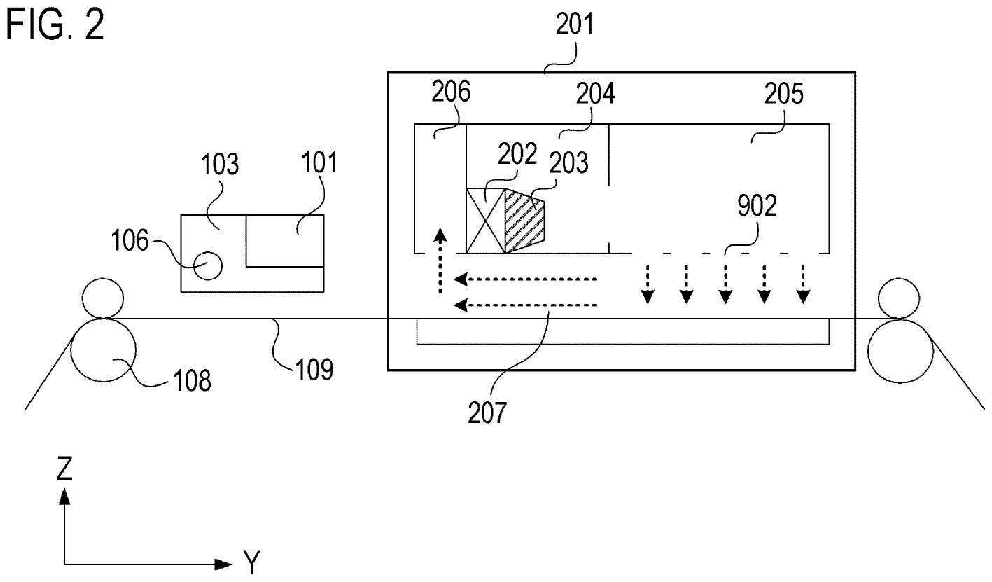

The recording medium 109 on which the ink has been ejected and an image has been formed is conveyed along the conveyance direction (Y direction), and hot air is applied to the surface on which the ink has been ejected by a heating and drying mechanism 201 shown in FIG. 2. As a result, the ink is heated and fixed. Resin fine particles described later can also be heated and can be formed into a coating film by the heating and drying mechanism 201. The resin fine particle is a substance for improving the scratch resistance of an image by forming a film by being applied onto the recording medium 109 followed by heating.

FIG. 2 is a view showing the configuration of the heating and drying mechanism 201 of Example. The heating and drying mechanism 201 is provided downstream of the recording heads 101 and 102 in the Y direction. The heating and drying mechanism 201 has jet stream holes 902 that are a plurality of air outlet ports arranged in the second direction (Y direction). The heating and drying mechanism 201 is a drying unit for drying the ink ejected onto the recording medium 109 by blowing a gas jet stream from above (in the +Z direction) of the recording medium 109 toward the surface of the recording medium 109 onto which the ink has been ejected from the jet stream holes 902.

The heating and drying mechanism 201 has: a blowing portion 202 having a blowing function; a heating portion 204 including a heating element 203 for heating the gas collected by the blowing portion 202; and a jet stream portion 205 for blowing the heated gas to the recording medium 109. The jet stream portion 205 is provided with a plurality of jet stream holes 902. Under the heating portion 204, there is a parallel flow portion 207 provided on the upstream side of the jet stream portion 205 in the Y direction (second direction) for drying the ink ejected to the recording medium 109 by flowing a gas along the surface of the recording medium 109 onto which the ink has been ejected. Although the parallel flow portion 207 is not configured such that warm air is blown from above the recording medium 109, it is configured such that the air ejected from the heating portion 204 flows as parallel flow along the surface of the recording medium 109. The evaporation of the ink film component proceeds also in the parallel flow portion 207.

When a jet stream is applied to the recording medium 109 immediately after ejection of the ink, image unevenness (jet stream unevenness) may occur due to the jet stream. For this reason, by arranging the parallel flow portion 207 on the upstream side in the second direction (Y direction) rather than the jet stream portion 205, first, the liquid component (moisture) of the ink is evaporated to some extent in the parallel flow portion 207, thereby suppressing the jet stream unevenness.

A gas is circulated in the heating and drying mechanism 201. As a result of this, it is possible to suppress power consumption. The flow of air through the heating and drying mechanism 201 is indicated with the dotted arrows in FIG. 2. The heated gas coming out of the jet stream portion 205 passes through the parallel flow portion 207 under the heating portion 204, and then is collected from the collection portion 206, so that the gas is circulated in the heating and drying mechanism 201. Note that the collection portion 206 is not required to be configured to collect and heat all the heated gases. In order to suppress a rise in humidity in the heating and drying mechanism 201, it may be configured such that the outside air is taken in to a certain extent.

The higher the drying efficiency of the heating and drying mechanism 201, the shorter the heating and drying time required for achieving the fixation of the ink film. For this reason, it becomes possible to reduce the size of the heating and drying mechanism 201. Further, the higher the drying efficiency of the heating and drying mechanism 201, the lower the electric power required for heating and drying by the heating and drying mechanism 201, so that the power consumption can be suppressed.

The heating and drying mechanism 201 uses a collision jet stream that causes the jet stream of a gas from the jet stream hole 902 in the jet stream portion 205 to collide with the recording medium 109. In other words, since the heated gas is sprayed to the heating object at a relatively larger wind velocity, the drying efficiency can be enhanced without increasing the heating temperature as much as possible. Cooling and heating of the object by the collision jet stream provide large heat transfer in the vicinity of the stagnation point (branch point) of the object surface against which the jet stream is collided. Further, the thermal load on the surface of the recording medium 109 can be adjusted by the diameter of the jet stream hole 902 and the distance between the jet stream hole 902 and the recording medium 109 against which the jet stream collides.

According to the heating and drying mechanism 201 using the collision jet stream, thermal damages such as overall expansion and contraction of the recording medium, and partial expansion and contraction and waving, and an increase in power consumption can be suppressed as compared with the case where the heating temperature is increased to increase the drying efficiency.

Incidentally, the heating temperature of the heating and drying mechanism 201 is desirably equal to or higher than the lowest film-forming temperature of the resin fine particles in order to heat the resin fine particles contained in the ink. Further, the temperature is desirably a temperature at which most of the liquid components such as the water-soluble organic solvent in the ink can be evaporated during heating. The higher the heating temperature, the higher the drying efficiency. Although the heating temperature has no restriction on the lower limit, it may be equal to or higher than 60° C., and even equal to or higher than 80° C. On the other hand, when the heating temperature is too high, the recording medium may be deformed. For this reason, although the heating temperature has no restriction on the upper limit, it may be 120° C. or less, and even 100° C. or less.

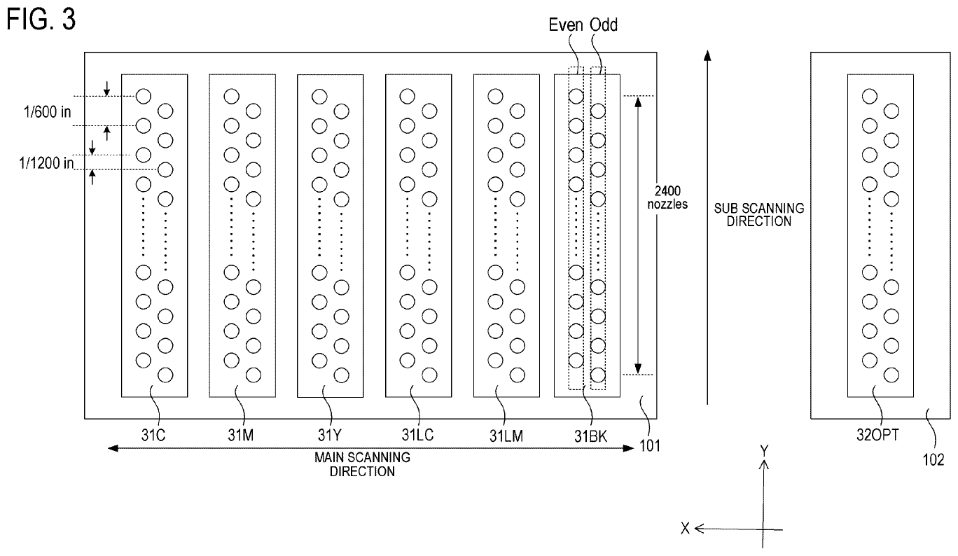

FIG. 3 is a view showing the configuration of the recording heads 101 and 102 of the recording apparatus 1 of the present Example. FIG. 3 is a view of the recording heads 101 and 102 viewed from the side of the recording medium 109, showing an ink ejection surface provided with recording element arrays (nozzle arrays). The recording heads 101 and 102 have a nozzle array (ejection port array) for each ink color and eject an ink for each ink color. The array of nozzles consists of a plurality of nozzles arranged in the Y direction, and in the present Example, the array of nozzles is configured such that 2,400 nozzles are arranged with a density of 1200 nozzles per inch (1200 dpi). In the recording apparatus 1 of the present Example, the recording head 101 for a color ink containing a coloring material and the recording head 102 for a reaction solution containing a component that insolubilizes or aggregates the coloring material of the color ink are separated. Thus, the adverse effects of the reaction due to the suspended mist can be suppressed.

The nozzle array 31C is a nozzle array in which nozzles for ejecting a cyan ink are arranged. The nozzle array 31M is a nozzle array in which nozzles for ejecting a magenta ink are arranged. The nozzle array 31Y is a nozzle array in which nozzles for ejecting a yellow ink are arranged. The nozzle array 31BK is a nozzle array in which nozzles for ejecting a black ink are arranged. The nozzle array 31LC is a nozzle array in which nozzles for ejecting a light cyan ink are arranged. The nozzle array 31LM is a nozzle array in which nozzles for ejecting a light-magenta ink are arranged. These nozzle arrays are arranged in an overlapping manner as viewed in the main scanning direction (X direction). Hereinafter, when the colors of the nozzle arrays 31C, 31M, 31Y, 31LC, 31LM, and 31BK are not distinguished, each may be referred to simply as the nozzle array 31.

In each of the nozzle arrays 31C, 31M, 31Y, 31LC, 31LM, and 31BK of the recording head 101, two columns of nozzle columns in each of which the nozzles are aligned at a density of 600 nozzles per inch (600 dpi) are arranged in the X direction. The two columns of the nozzle columns (referred to as Even column and Odd column) are arranged shifted by 1/1200 inches in the sub scanning direction so that the nozzles of both are arranged in a staggered manner as a whole. By considering these two columns as one nozzle array, 1200 dots can be formed per inch on the recording medium 109. That is, the recording heads 101 and 102 can form images with a recording density of 1200 dpi (dot/inch) in the sub scanning direction. By ejecting ink droplets from each nozzle while moving the recording heads 101 and 102 in the main scanning direction, dots are recorded on the recording medium 109 at a density of 2400 dpi in the main scanning direction and 1200 dpi in the sub scanning direction.

Incidentally, the amount of the ink droplets ejected from each nozzle (ejection amount) is about 5 pl. However, with regard to the black ink, the ejection amount may be set to be larger than those of the inks of other colors in order to achieve a high density. The recording heads 101 and 102 of the present Example eject an ink using thermal energy. Each recording element has an electro-thermal transducer for generating thermal energy.

Note that the ink ejection method is not limited to the method utilizing thermal energy, and may be another method such as a method of ejecting an ink by a piezoelectric element. Further, the recording head 101 for ejecting inks of 6 colors of C, M, Y, LC, LM, and BK may be independently configured for each color, or may be integrally configured. In addition to the above inks of six colors, a red ink, a green ink, a blue ink, and the like may be used for the purpose of improving the color development, and a white ink may be added for the purpose of improving the color development of the film.

The recording head 102 for the reaction solution has a nozzle array 32OPT for ejecting the reaction solution consisting of 2,400 nozzles (recording elements) arranged at a density of 1200 nozzles per inch as with the recording head 101.

When an ink is ejected by the recording head, suspended mist is generated. In the present Example, the color ink recording head 101 and the reaction solution recording head 102 are configured separately. Thus, as compared with the case where the recording head for a color ink and the recording head for a reaction solution are integrated, the floating mists are prevented from reacting and aggregating on the ejection surface of the recording head. Note that the color ink recording head and the reaction solution recording head may be integrated. In this case, the reaction due to the suspended mist can be reduced by increasing the gap between the nozzle array for the color ink and the nozzle array for the reaction solution. Note that the size of the recording head can be reduced by reducing the gap between the nozzle arrays.

### Maintenance Mechanism

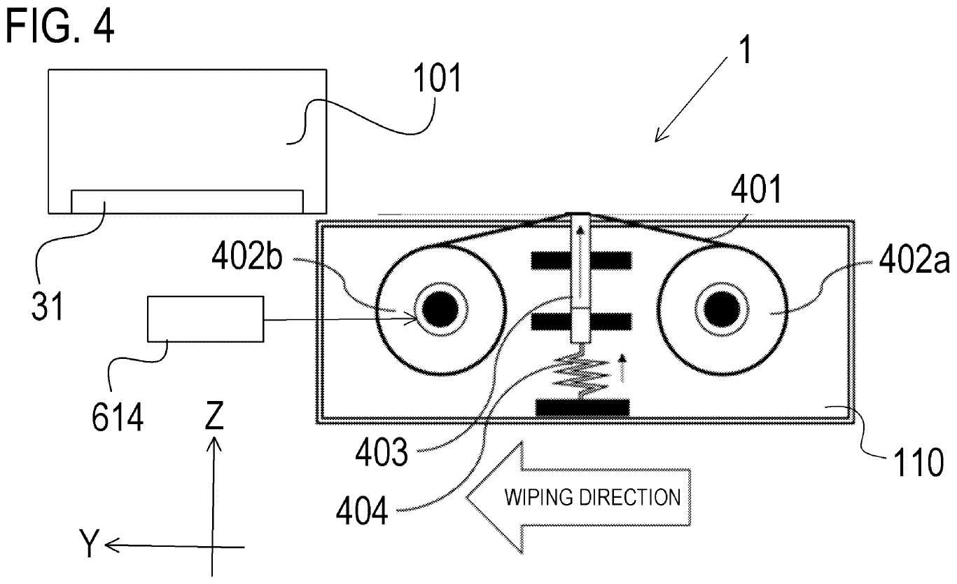

FIG. 4 is a cross sectional view showing a maintenance mechanism 110 of the recording apparatus 1 of Example. The maintenance mechanism 110 has a wiping member 401 including a sheet-like porous material capable of wiping off the ink deposited on the ink ejection surfaces of the recording head 101 and the recording head 102 (not shown).

The unused wiping member 401 (before wiping off an ink) is wound around a first rotating member 402a. A second rotating member 402b is arranged on the downstream side of the first rotating member 402a in the conveyance direction (Y direction) of the recording medium 109.

The tip of the wiping member 401 is attached to the second rotating member 402b, and the used (ink has been wiped off) wiping member 401 is wound around the second rotating member 402b driven by a wiping operation motor 614. As a result of this, the wiping member 401 can be conveyed in the downstream direction (Y direction) in the conveyance direction of the recording medium 109.

On the other hand, the first rotating member 402a rotates following the rotation of the second rotating member 402b. The conveyance amount (conveyance length) of the wiping member 401 is controlled by the amount of rotation of the wiping operation motor 614. Incidentally, the amount of conveyance of the wiping member 401 can also be controlled on the basis of the results of measurement by the measuring unit using optical unit.

A pressing member 403 is disposed between the first rotating member 402a and the second rotating member 402b. The pressing member 403 pushes up the wiping member 401 upward (in the Z direction) with a constant load by a compression spring 404. By pushing up the wiping member 401 to a predetermined position by the pressing member 403, a part of the wiping member 401 comes into contact with the nozzle array 31 of the recording head 101.

The cleaning effect by the wiping operation increases with an increase in the length in the nozzle column direction (Y direction, wiping direction) of the wiping member 401 to be brought into contact with the nozzle array 31 by the pressing member 403. In the present Example, the length in the Y direction of the wiping member 401 to be brought into contact with the nozzle array 31 by the pressing member 403 is about 5 mm. Further, the width (the length in the X direction) of the wiping member 401 to be brought into contact with the recording head 101 by the pressing member 403 is a width enough to be able to wipe all of the nozzle arrays 31 of the recording head 101. In the present Example, by setting the width of the pressing member 403 longer than the width of the recording head 101, the width of the wiping member 401 to be brought into contact with the recording head 101 by the pressing member 403 was set substantially the same as the width of the recording head 101.

Note that one wiping member 401 may be configured, or a plurality of wiping members 401 may be configured. For example, a plurality of wiping members 401 may be provided which differ depending on the positions of the ink nozzle arrays 31 of each ink of the recording head 101. Further, when there are a plurality of recording heads, each recording head may include a plurality of wiping members 401. The number of divisions of the wiping member 401, their respective widths and lengths, and the like are not limited to the above examples.

Although a non-woven fabric of polyester short fibers was used for the wiping member 401 of the present Example, the raw materials and methods thereof are not particularly limited. The non-woven fabric is configured in a sheet shape in which fibers are bonded or entwined together by fusion, or mechanical or chemical action. Further, the wiping member 401 may be a sheet-like member of a long fiber knitted fabric or woven fabric. Further, as a material for the wiping member 401, a mixture of polyester and nylon, cotton, or the like is used.

### Wiping Operation

In the present Example, the wiping operation is performed at least at the timing during the recording operation. That is, between the first main scan and the subsequent second main scan, the wiping operation is performed as a predetermined interruption operation. It should be noted that, as other timings to perform the wiping operation, mention may be made of the time at which the recording is started, the interval between pages, before the cap closing operation, during a cleaning sequence (during a suction recovery sequence) and the like.

The wiping operation at the time of start of the recording operation is the wiping operation to be performed before the first page is recorded. Even when the ejection surface is stained with the ink deposited to the cap at the time of standby or the mist is deposited to the ejection surface by the preliminary ejection performed during standby, wiping off can be achieved by the wiping operation at the time of start of the recording operation.

The wiping operation during the recording operation is performed as a periodic maintenance. As a result of this, it is suppressed that the mists of the self-color or other-color inks from the recording heads 101 and 102 generated during the recording operation cover the nozzles, and are deposited onto the ejection surfaces for fixation, and a large amount of mists gather and drop as large droplets.

The inter-page wiping operation is a wiping operation to be performed at a timing of before recording the next page after completion of the recording of the previous page. Also included is a wiping operation to be performed at a timing when the recording medium 109 is cut by cutter processing after the completion of recording of all pages.

The wiping operation before the cap closing operation is performed in order to perform maintenance before capping the recording heads 101, 102 after completion of recording.

The wiping operation during the cleaning sequence is performed in order to wipe out a large amount of the ink droplets deposited on the ejection surface after recovery processing such as ink suction using the cap is performed.

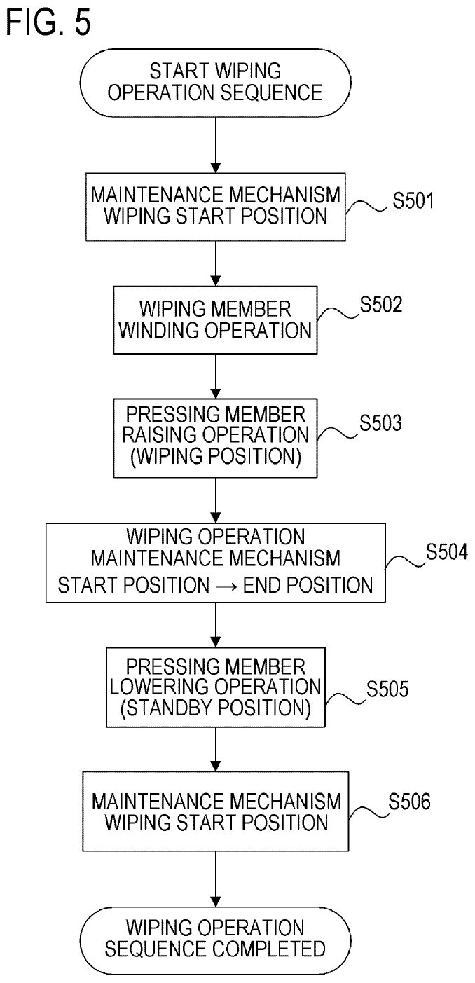

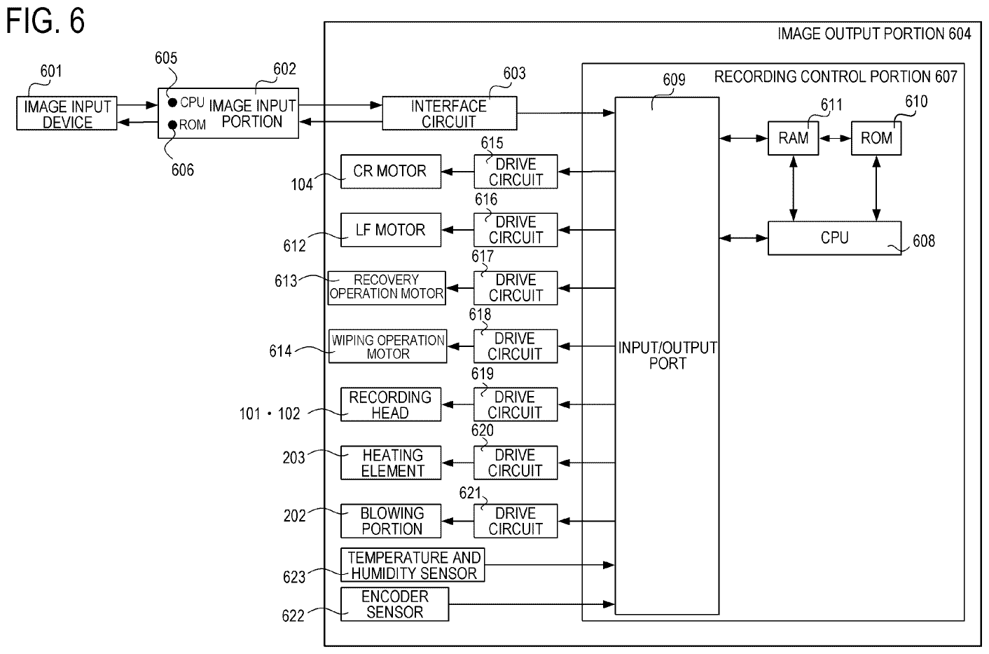

FIG. 5 is a flowchart showing the wiping operation sequence of Example. The processing of the flowchart is carried out by a CPU 608 of a recording control portion 607 of FIG. 6.

In a step S501, the CPU 608 moves the carriage 103 to the top of the maintenance mechanism 110 and moves the maintenance mechanism 110 to the wiping start position. In a step S502, the CPU 608 winds up the wiping member 401 contaminated with an ink by the previous wiping operation by a predetermined length, and presses the unused part thereof against the ejection surfaces of the recording heads 101 and 102 by the pressing member 403. For example, the CPU 608 performs, as a winding operation, winding for about 5 mm, which is the length of the part to be brought into contact with the nozzle array 31.

In a step S503, the CPU 608 raises the pressing member 403 and moves it to the wiping position. In a step S504, the CPU 608 performs a wiping operation. That is, the CPU 608 moves the maintenance mechanism 110 from the wiping start position to the wiping end position. In a step S505, the CPU 608 lowers the pressing member 403 and moves it to the standby position. In a step S506, the CPU 608 returns the maintenance mechanism 110 to the wiping start position.

### Composition of Ink

Next, ink prescription in the present Example will be described in details. The present disclosure is not limited by the following Examples at all, unless beyond its gist. Note that the statements “part” and “%” are based on mass unless otherwise specified.

### Formation of Resin Fine Particle Dispersion Liquid

The ink of Example 1 contains resin fine particles for causing the recording medium to adhere to the coloring material to improve the scratch resistance (fixing property) of the recorded image. The resin fine particles are melted by heat, and film formation of the resin fine particles and drying of the solvent contained in the ink are performed by a heater. In the present Example, the “resin fine particles” means polymer fine particles present in a dispersed state in water. Specifically, an acrylic resin fine particle synthesized by emulsion polymerization of monomers such as (meth)acrylic acid alkyl ester and (meth)acrylic acid alkyl amide. A styrene-acrylic resin fine particle synthesized by emulsion polymerization of a monomer of styrene with an (meth)acrylic acid alkyl ester, (meth)acrylic acid alkyl amide, or the like, or by other methods. Mention may be made of polyethylene resin fine particles, polypropylene resin fine particles, polyurethane resin fine particles, styrene-butadiene resin fine particles, and the like. Alternatively, core-shell type resin fine particles different in polymer composition between the core part and the shell part constituting the resin fine particles, resin fine particles obtained by using acrylic fine particles synthesized in advance to control the particle diameters as seed particles and performing emulsion polymerization therearound, and the like are also acceptable. Still alternatively, hybrid resin fine particles formed by chemically bonding different resin fine particles such as acrylic resin fine particles and urethane resin fine particles or the like are also acceptable.

Further alternatively, the “polymer fine particles present in a state of being dispersed in water” may be in a form of resin fine particles obtained by homopolymerizing a monomer having a dissociative group or copolymerizing a plurality of monomers, so-called self-dispersing resin fine particle dispersion. Here, as the dissociative groups, mention may be made of a carboxyl group, a sulfonic acid group, a phosphoric acid group, and the like. As the monomers having the dissociative groups, mention may be made of acrylic acid, methacrylic acid, and the like. Still further alternatively, a so-called emulsion dispersion type resin fine particle dispersion in which resin fine particles are dispersed by an emulsifier is also acceptable. As the emulsifier, a material having anionic charge can be used regardless of whether it has a low molecular weight or a high molecular weight.

With the resin fine particle dispersion liquid used in the present Example, first, the following three additive liquids were added dropwise little by little with stirring in a state heated to 70° C. under a nitrogen atmosphere, and polymerization was performed for 5 hours. Respective additive liquids are a hydrophobic monomer including 28.5 parts of methyl methacrylate, a mixed solution containing a hydrophilic monomer including 4.3 parts of sodium p-styrenesulfonate and 30 parts of water, and a mixed solution containing a polymerization initiator including 0.05 part of potassium persulfate and 30 parts of water. In this manner, a 20 mass % of resin fine particle dispersion liquid was obtained.

Methods of preparing each ink and reaction solution will be described below.

### Preparation of Black Pigment Dispersion Liquid

First, an anionic polymer P-1 [styrene/butyl acrylate/acrylic acid copolymer (polymerization ratio (weight ratio)=30/40/30), acid value 202, and weight average molecular weight 6500] was prepared. The resulting polymer was neutralized with an aqueous potassium hydroxide solution, and was diluted with ion exchanged water to manufacture a homogeneous 10 mass % aqueous polymer solution.

Six hundred grams of the polymer solution, 100 g of carbon black, and 300 g of ion exchanged water were mixed, and the resulting solution was mechanically stirred for a predetermined time, and then the non-dispersed material containing coarse particles was removed by a centrifugation treatment, resulting in a black dispersion liquid. The resulting black dispersion liquid had a pigment concentration of 10 mass %.

### Preparation of Magenta Pigment Dispersion Liquid

First, an AB type block polymer having an acid value of 300 and a number average molecular weight of 2500 was formed by a conventional method using benzyl acrylate and methacrylic acid as raw materials, was neutralized with an aqueous potassium hydroxide solution, and was diluted with ion exchanged water, thereby manufacturing a homogeneous 50 mass % aqueous polymer solution.

One hundred grams of the polymer solution, 100 g of C.I.pigment red 122, and 800 g of ion exchanged water were mixed, and the resulting solution was stirred mechanically for a predetermined time. Then, non-dispersed materials containing coarse particles were removed by a centrifugation treatment, resulting in a magenta dispersion liquid. The resulting magenta dispersion liquid had a pigment concentration of 10 mass %.

### Preparation of Cyan Pigment Dispersion Liquid

First, an AB type block polymer having an acid value of 250 and a number average molecular weight of 3000 was formed by a conventional method using benzyl acrylate and methacrylic acid as raw materials. The resulting solution was neutralized with an aqueous potassium hydroxide solution, and was diluted with ion exchanged water, thereby manufacturing a homogeneous 50 mass % aqueous polymer solution.

Two hundred grams of the above polymer solution, 100 g of C.I.pigment blue 15:3, and 700 g of ion exchanged water were mixed, and the resulting solution was stirred mechanically for a predetermined time. Then, non-dispersed materials containing coarse particles were removed by a centrifugation treatment, resulting in a cyanogen dispersion liquid. The resulting cyanogen dispersion liquid had a pigment concentration of 10 mass %.

### Preparation of Yellow Pigment Dispersion Liquid

First, the anionic polymer P-1 was neutralized with an aqueous potassium hydroxide solution and was diluted with ion exchanged water to manufacture a homogeneous 10 mass % aqueous polymer solution.

Three hundred grams of the above polymer solution, 100 g of C.I.pigment yellow 74, and 600 g of ion exchanged water were mixed, and the resulting mixed solution was stirred mechanically for a predetermined time. Then, non-dispersed materials containing coarse particles were removed by a centrifugation treatment, resulting in a yellow dispersion liquid. The resulting yellow dispersion liquid had a pigment concentration of 10 mass %.

### Ink Preparation

Respective components (unit: %) shown in the upper stage of Table 1 were mixed. Then, pressure filtering was performed through a membrane filter (HDCII filter; manufactured by PALL) with a pore size of 1.2 μm, thereby preparing pigment inks 1 to 6, respectively. The amount of ion exchanged water used was set to a content such that the total amount of components was 100.0%. Incidentally, Acetinol E100 is a surfactant manufactured by Kawaken fine chemical. In the lower stage of Table 1, the content of pigment (unit: %) in the pigment ink is shown. Each ink thus obtained was filled into its corresponding cartridge.

TABLE 1
Composition and characteristics of ink

| | 1 | 2 | 3 | 4 | 5 | 6 |
|---|---|---|---|---|---|---|
| Ink name | BK | C | LC | M | LM | Y |
| Black pigment dispersion liquid | 20 | — | — | — | — | — |
| Cyan pigment dispersion liquid | — | 25 | 5 | — | — | — |
| Magenta pigment dispersion liquid | — | — | — | 30 | 6 | — |
| Yellow pigment dispersion liquid | — | — | — | — | — | 35 |
| Resin fine particle dispersion liquid | 40 | 40 | 40 | 40 | 40 | 40 |
| Zonyl FSO-100 | 0.05 | 0.05 | 0.05 | 0.05 | 0.05 | 0.025 |
| (fluorine-based surfactant manufactured by | | | | | | |
| DuPont) | | | | | | |
| 2-Methyl-1,3-propanediol | 15 | 15 | 15 | 15 | 15 | 15 |
| 2-Pyrrolidone | 5 | 5 | 5 | 5 | 5 | 5 |
| Acetylene glycol EO adduct | 0.5 | 0.5 | 0.5 | 0.5 | 0.5 | 1 |
| (manufactured by Kawaken fine Chemical | | | | | | |
| Co., Ltd.) | | | | | | |
| Ion exchange water | Balance | Balance | Balance | Balance | Balance | Balance |
| Pigment concentration | 2 | 2.5 | 0.5 | 3 | 0.6 | 3.5 |

### Preparation of Reaction Solutions

The reaction solution used in the present Example contains a reactive component that reacts with the pigment contained in the ink to aggregate or gel the pigment. This reactive component is specifically a component capable of destroying the dispersion stability of an ink having a pigment stably dispersed in an aqueous medium by the action of an ionic group when mixed with the ink on a recording medium or the like. Particularly, magnesium sulfate is used in the present Example.

It should be noted that magnesium sulfate is not necessarily required to be used, and in the present Example, various organic acids or multivalent metal salts can be used as reactive components of the reaction solution so long as they are water soluble. The content of the organic acid or the multivalent metal salt may be at least 0.1 mass % and not more than 90.0 mass %, and even at least 1.0 mass % and not more than 70.0 mass % based on the total mass of the composition included in the reaction solution.

### Manufacturing of Ink

In the present Example, as described above, magnesium sulfate (manufactured by Fuji Film Wako Pure Chemical Co., Ltd.) was used and the following components were mixed to manufacture a reaction solution 1.
Magnesium sulfate 2 parts
2-Pyrrolidone 5 parts
2-Methyl 1,3 propanediol 15 parts
Acetylene glycol EO adduct 0.5 part
Ion exchange water/balance (manufactured by Kawaken fine Chemical Co., Ltd.)

### Image Processing System Configuration Example

FIG. 6 is a block diagram showing a functional configuration (control configuration) of the recording apparatus 1 of the present Example. First, image data (multi-value data) stored in an image input device 601 such as a scanner or a digital camera and various storage media such as a hard disk is inputted to an image input portion 602. The image input portion 602 is a host computer connected to the outside of the recording apparatus 1, and transfers image information (image data) to be recorded to the image output portion 604 which is the recording apparatus 1 via an interface circuit 603. In the image input portion 602, a CPU 605 and a storage element (ROM 606) necessary for transferring image data are arranged. As the form of the host computer, a computer as an information processing device can be adopted, or other than this, the form of an image reader or the like can also be adopted.

The recording control portion 607 has a CPU 608, an input/output port 609, a storage element (ROM 610) storing a control program, etc., and a RAM 611 to serve as a work area for carrying out various image processing. The ROM 610 stores various data such as a control program for the CPU 608 and parameters necessary for the recording operation. The RAM 611 is used as a work area for the CPU 608, and temporarily stores various data such as image data received from the image input portion 602 and generated recording data. Then, on the basis of the image data converted at the recording control portion 607, an image is formed by applying ink to the recording medium 109 from each of the nozzles of the recording heads 101 and 102.

The recording control portion 607 is connected to the carriage motor 104 in the conveyance unit, the conveyance motor 612 (also referred to as an LF motor), and the drive circuits 615, 616, and 619 of the recording heads 101 and 102 via the input/output port 609. Further, the recording control portion 607 is connected to drive circuits 617 and 618 of the recovery operation motor 613 and the wiping operation motor 614 via the input/output port 609. The recovery operation motor 613 is a drive source for performing the ink suction operation from each of the nozzles in the recovery operation of a recovery processing unit (not shown) for recovering the ejection of the non-ejection nozzles of the recording heads 101 and 102. Further, the recording control portion 607 is also connected to a drive circuit 620 for driving the heating element 203 of the heating and drying mechanism 201 and a drive circuit 621 for driving the blowing portion 202 via the input/output port 609.

Further, sensors such as a temperature and humidity sensor 623 for detecting the temperature and humidity of the surrounding environment are connected to the input/output port 609. Further, a signal from an encoder sensor 622 for detecting the position of the carriage 103 is also inputted to the recording control portion 607 via the input/output port 609. The recording control portion 607 is a control unit for controlling the main scan of ejecting ink to the recording medium 109 by the recording heads 101 and 102 and the sub scan of conveying the prescribed conveyance amount of the recording medium 109 by the conveyance unit (conveyance roller pair 108) so as to be performed alternately.

### Block Diagram

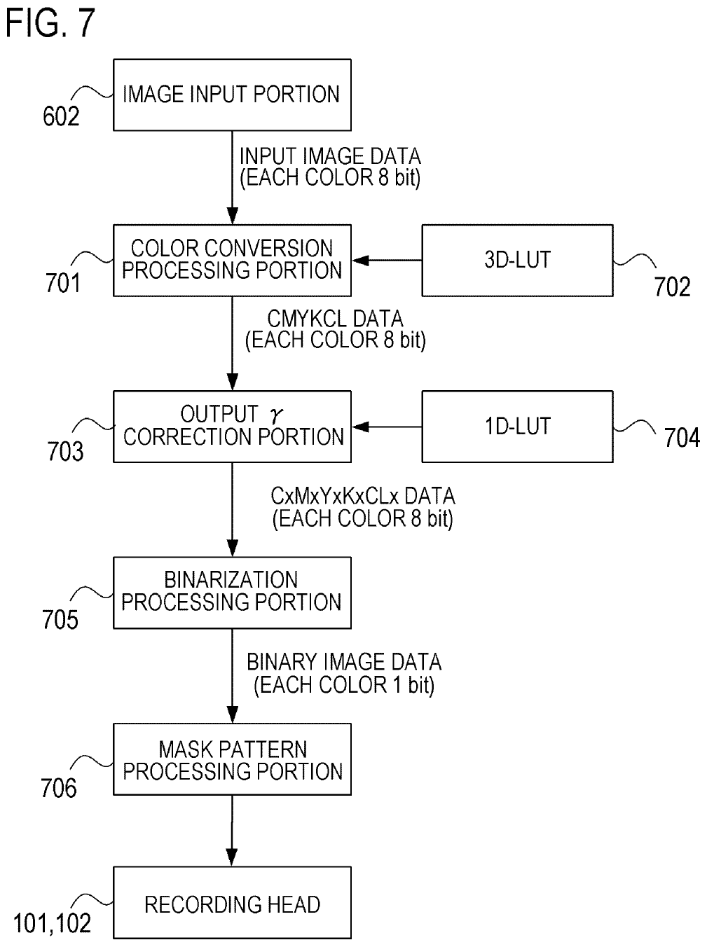

FIG. 7 is a block diagram illustrating a functional configuration of the recording control portion 607 shown in FIG. 6. The recording control portion 607 determines which nozzle is used to perform recording on the recording medium 109 for each pixel of the image data.

Input image data including 8 bits of each of R, G, and B colors inputted from the image input portion 602 is inputted to a color conversion processing portion 701 to be converted to C, M, Y, and K density signals. The color conversion processing portion 701 converts input image data (RGB data) into multi-gradation data (CMYK data) of a plurality of ink colors available for the recording apparatus 1 for each pixel while referring to a 3D-LUT 702 which is a three-dimensional color conversion look-up table.

The number of dimensions of the color conversion look-up table of the 3D-LUT 702 means the number of components of the input image data to be inputted to the color conversion processing portion 701. A density signal for a specific and discrete RGB signal is held in the 3D-LUT 702. For an RGB signal whose value is not held in the 3D-LUT 702 among combinations of all values of RGB expressed in 256 stages of each color, the color conversion processing portion 701 uses a plurality of held data to obtain a CMYK signal by interpolation processing. Since the interpolation processing method is a known technique, detailed description thereon will be omitted. The value of the multi-gradation data (CMYK data) acquired by the color conversion processing portion 701 is expressed in 8 bits as with the input image data that is an input value, and is outputted as density data having 256-stage gradation values.

The CMYK data subjected to color conversion in the color conversion processing portion 701 is then subjected to conversion processing by an output γ correction portion 703. The output γ correction portion 703 performs correction for each ink color with reference to a 1D-LUT 704 which is a one-dimensional color conversion look-up table so that the optical density finally expressed on the recording medium 109 may keep the linearity with respect to the input density signal. The CxMxYxKx data, which is an output signal from the output γ correction portion 703 is 8-bit density data as with the input image data.

The 8-bit density data is converted into 1-bit binary image data in which the positions of the dots to be recorded by the recording heads 101 and 102 are determined by a binarization processing portion 705. The binarization processing portion 705 can employ general multi-value error diffusion processing.

On the basis of the binary image data, a mask pattern processing portion 706 selects the mask pattern to be used to create output image data for each main scan.

The optimal conversion methods in the color conversion processing portion 701, the output γ correction portion 703, and the binarization processing portion 705 described up to this point differ depending on the type of the recording medium 109, the type of the image to be recorded, and the like. In particular, the three-dimensional color conversion look-up table of the 3D-LUT 702 used in the color conversion processing portion 701 is prepared for each type of the recording medium 109.

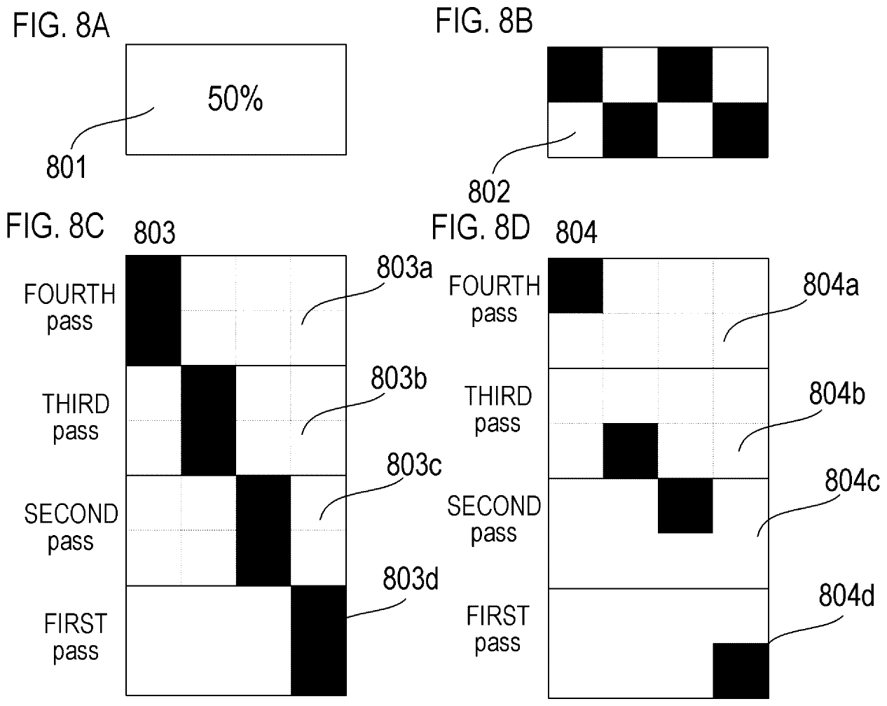

FIGS. 8A to 8D are each a view illustrating the recording method of the recording apparatus 1 of the present Example. The mask pattern to be used in the mask pattern processing portion 706 is stored in the ROM 610 of the recording control portion 607. The mask pattern processing portion 706 divides the recording data of each color for each recording scan by using the mask pattern, and generates dot data to be recorded for each recording scan of each color.

FIG. 8A shows the recording DUTY of the unit pixel 801, and in this example, the recording DUTY of the unit pixel 801 is 50%. The unit pixels 801 are subjected to binarization processing and resolution conversion in the binarization processing portion 705 to generate binary image data 802 shown in FIG. 8B. In this example, the binary image data 802 includes 4 dots×2 dots. In FIG. 8B, the blacked out part indicates the dot on which the recording is performed. In this example, the dot on which recording is performed is 4 dots out of 8 dots, which results in a recording DUTY of 50%.

The mask pattern 803 in FIG. 8C is an example of the mask pattern to be used for four-pass multi-pass recording in which an image is recorded by four recording scans. The mask pattern defines a recorded/non-recorded part for each dot. In FIG. 8C, the black area indicates the dot that allows recording, and the white area indicates the dot that does not allow recording. The recording tolerances of the four mask patterns 803a, 803b, 803c, and 803d are each equally 25% and are in a complementary relationship to one another.

The nozzles in the nozzle array 31 are divided into four regions in the vertical direction (Y direction), and respective regions correspond to the mask patterns 803a to 803d, respectively. The nozzles included in each region record dots according to the mask patterns 803a to 803d corresponding to respective regions, respectively. By taking the logical AND of the mask patterns 803a to 803d and the binary image data 802 generated by the binarization processing portion 705 in each recording scan, the dot to be actually recorded in each recording scan is determined.

The output image data 804 in FIG. 8D shows the positions of the dots to be recorded in each recording scan. In the example of FIG. 8D, it can be seen that one dot is recorded for every recording scan. For example, output image data 804b to be recorded by second recording scan is obtained from the logical product of the binary image data 802 and the mask pattern 803b. Only when there are dots to be recorded in the binary image data 802 and the mask pattern 803 allows recording, the dots are actually recorded.

When a dot is actually recorded on the recording medium 109, a constant conveyance amount (a prescribed conveyance amount) of the recording medium 109 is conveyed each time the recording scan is carried out once, thereby achieving the overlap of the recording in a plurality of recording scans. In the examples of FIGS. 8A to 8D, the data shown in the binary image data 802 is recorded when two dots are conveyed per recording scan. This amount of conveyance is also referred to as a recording scanning width.

Incidentally, although FIG. 8 shows a mask pattern having a 4-dot×2-dot region for the sake of simplicity of description, the actual mask pattern may have a still larger region in both the main scanning direction and the sub scanning direction. In particular, in the sub scanning direction, generally, the number of nozzles in the nozzle array of the recording head is made equal to the number of pixels in the mask pattern.

As described up to this point, the dot allowed to be recorded is determined for each recording operation, and a plurality of recordings are repeated, whereby the ink of the target recording DUTY is recorded on the recording medium 109. The ink applied onto the recording medium 109 exhibits robustness by evaporating most of the liquid components such as the water-soluble organic solvent in the heating and drying mechanism 201 to deposit the fine resin particles contained in the ink. In the present Example, it is configured such that the heating and drying mechanism 201 uses a collision jet stream. In a drying device using a collision jet stream, image unevenness (also referred to as jet stream unevenness) due to the difference in evaporation rate may occur.

### Mechanism of Jet Stream Unevenness

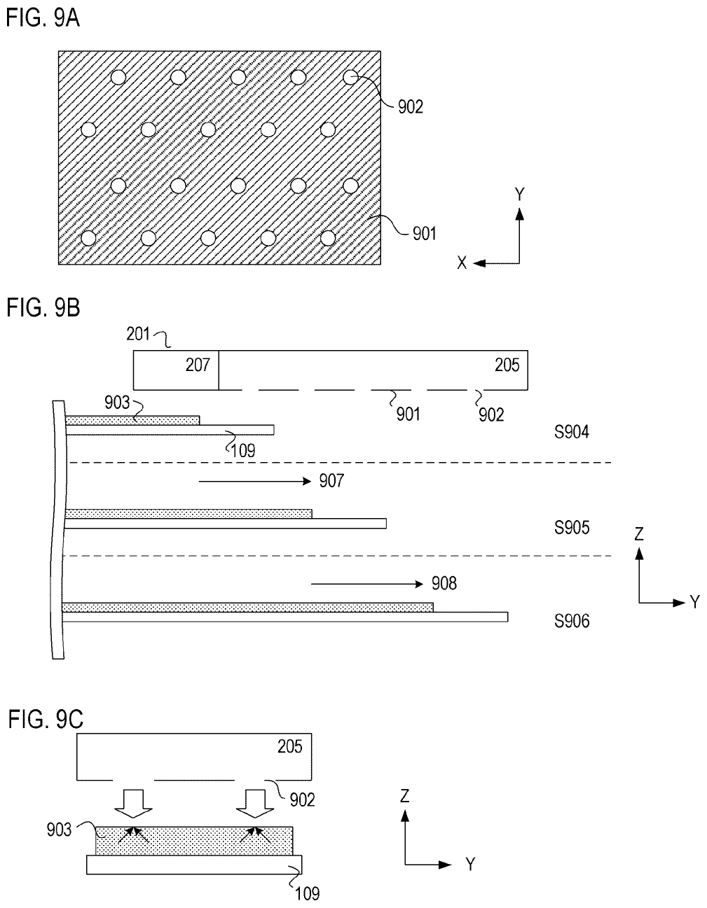

Details of the jet stream unevenness will be described below with reference to FIGS. 9A to 9C. FIG. 9A is a view of the jet stream portion 205 of the heating and drying mechanism 201 as viewed in the Z direction. In the part of the jet stream portion 205 facing the recording medium 109, jet stream holes 902 are opened at a uniform pitch on the metal plate 901. In the present Example, the diameter of the jet stream hole 902 is 1 mm. Although the efficient pitch layout varies depending on the size of the jet stream holes 902, the distance between the centers of the jet stream holes 902 (the distance in the X direction) is 3.5 mm in the present Example. Note that the size and the pitch of the jet stream holes 902 are examples. A size of the jet stream hole 902 of 0.5 mm in diameter or 2 mm in diameter provides the effect of the present Example. The pitch of the jet stream holes 902 may be varied depending on the size of the jet stream hole 902.

In the heating and drying mechanism 201 using a jet stream, in principle, a difference in evaporation rate depending on the difference in heat transfer rate may occur between immediately under and around the jet stream hole 902.

FIG. 9B shows a state in which the ink film 903 ejected to the recording medium 109 during the recording operation by the recording heads 101 and 102 enters immediately under the jet stream portion 205 in the heating and drying mechanism 201 in accordance with conveyance by the sub scan. The recording apparatus 1 of the present Example performs recording by a serial scan method in which main scan and sub scan are alternately repeated. In FIG. 9B, conveyance 907 of the recording medium 109 is carried out in the Y direction between the stop period S904 and the stop period S905, and conveyance 908 of the recording medium 109 is carried out in the Y direction between the stop period S905 and the stop period S906. During each stop period, the recording heads 101 and 102 perform a recording operation for one recording scan. While the recording heads 101 and 102 are performing the recording operation, conveyance of the recording medium 109 is not carried out.

The ink film 903 ejected to the recording medium 109 advances in the heating and drying mechanism 201 as the conveyances 907 and 908 progress during the stop periods S904, S905, and S906. The amount of movement of the recording medium 109 on which the ink film 903 is formed per one conveyance is determined by the amount of conveyance of the recording medium 109 carried out immediately under the recording heads 101 and 102. That is, the conveyance amounts in the conveyance 907 and the conveyance 908 in the heating and drying mechanism 201 are equal to the recording scanning width. Considering only the fixation of the ink film 903, it is not necessary to make the amount of conveyance equal to the width of the recording scanning because it suffices that the time required for the ink film 903 to pass through the inside of the heating and drying mechanism 201 can be secured. However, in the present Example, it is configured such that simultaneously with performing multi-pass recording on the recording medium 109, the ejected ink film 903 is fixed and dried. Since the recording medium 109 is conveyed so as to prevent the overlapping of the dots in the above-described recording scan from shifting, the carrying amount and the recording scan width become the same unless conveyance is carried out in the reverse direction.

When a collision jet stream is applied to the ink film 903 on the recording medium 109, film formation unevenness due to the difference in evaporation rate may occur, and image unevenness (jet stream unevenness) visually recognized as a gloss difference (gloss unevenness) may occur. Generally, when there is a difference in evaporation rate during the drying process of the liquid film, a phenomenon (convection) occurs in which the liquid component is attracted to a region where the evaporation rate is high in accordance with the evaporation. As shown in FIG. 9C, it is considered that the difference in evaporation rate is caused, thereby generating unevenness in the distribution of the ink components in the ink film 903, leading to image unevenness after fixation. The jet stream unevenness becomes more remarkable with an increase in the amount of the reaction solution deposited. This can be considered due to the fact that the difference in physical properties between the reaction solution and the color ink causes the difference in evaporation rate to cause in-plane ink component non-uniformity more remarkably.

The effect of the difference in evaporation rate due to the collision jet stream becomes more remarkable with an increase in the length of time during which the ink film 903 stops under the jet stream. With the serial scan type recording method, the recording medium 109 will stop under the jet stream while the recording heads 101 and 102 record data for one record scan. By evaporating moisture to some extent before entering the lower part of the collision jet stream, jet stream unevenness due to the difference in evaporation rate can be suppressed. In order to perform moisture evaporation upstream of the collision jet stream, in the present Example, as described with reference to FIG. 2, a parallel flow portion 207 is provided on the upstream side of the jet stream portion 205 onto which the collision jet stream is applied to promote moisture evaporation. As a result of this, the moisture in the ink film 903 is evaporated to increase the viscosity of the entire ink film 903, which can suppress the convection in the ink film 903, and can suppress the influence of the difference in evaporation rate in the jet stream portion 205. It should be noted that a drying device may be provided separately on the upstream side of the collision jet stream.

Here, when recording is stopped (conveyance is stopped) due to an interruption operation such as a wiping operation performed between the first main scan and the subsequent second main scan, the stop period of the recording medium 109 in the jet stream portion 205 becomes longer. In this case, even when the moisture of the ink film 903 is evaporated to some extent in the parallel flow portion 207 upstream of the jet stream portion 205, there is a possibility that the jet stream unevenness may occur. By increasing the size of the parallel flow portion 207 in the conveyance direction, it is possible to suppress jet stream unevenness when recording is stopped. This leads to an increase in the size of the heating and drying mechanism 201.

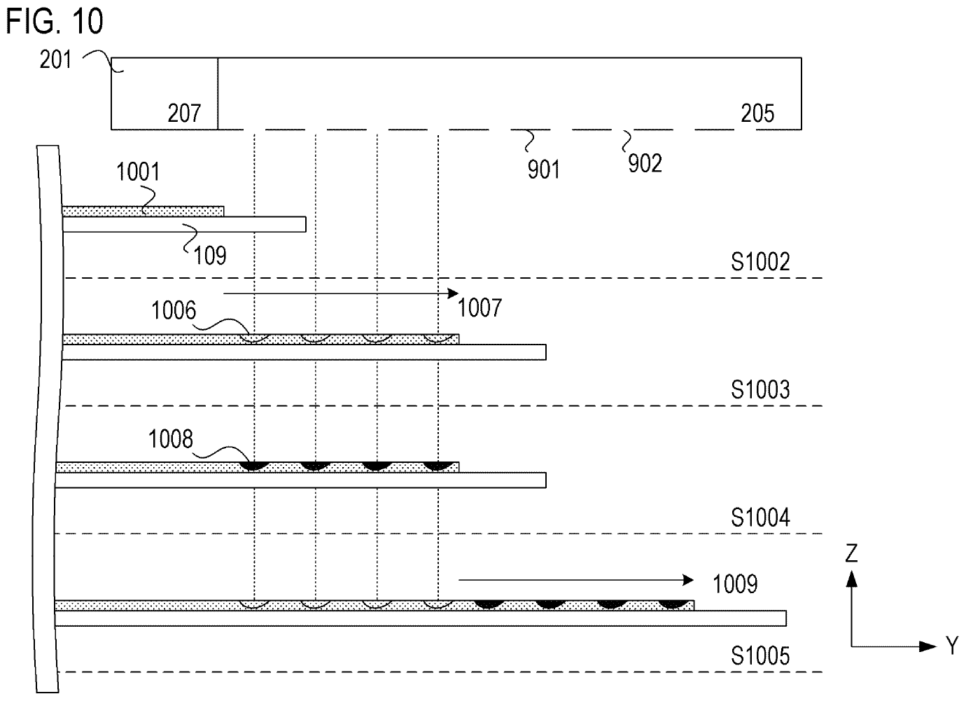

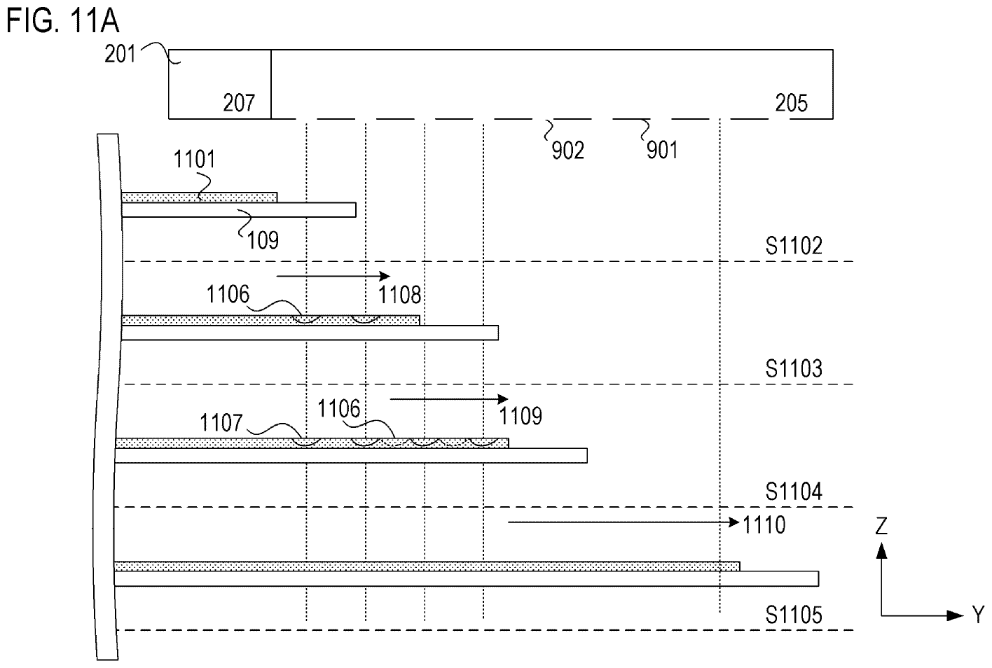

FIG. 10 is a view schematically showing a state in which jet stream unevenness occurs when a wiping operation is interposed during a recording operation. The ink film 1001 ejected to the recording medium 109 enters the inside of the heating and drying mechanism 201 by conveyance after ejection of the ink film 1001 as shown in a state S1002. At this time, the ink film 1001 is at the position of the parallel flow portion 207, and the evaporation of the moisture mainly progresses by the parallel flow of warm air. Recording scan is performed by the recording heads 101 and 102, a conveyance operation of a recording scanning width indicated with an arrow 1007 is performed, and a region 1006 of the ink film 1001 is positioned immediately under the jet stream hole 902 as shown in a state S1003. Incidentally, the single conveyance operation is controlled by trapezoidal driving in which acceleration in, for example, acceleration, constant speed, or deceleration is constant, or S-shaped driving in which speed changes in trapezoidal driving are made smooth.

When a wiping operation is interposed as an interruption operation at the stage of completion of the conveyance operation indicated with an arrow 1007, the jet stream continues to hit the region 1006 for a time longer than a normal recording scanning time, and the jet stream unevenness 1008 occurs as shown in a state S1004. Subsequently, by carrying out the recording scan and the conveyance operation of the recording scanning width indicated with an arrow 1009, the region 1006 moves from the opposite position immediately under the jet stream hole 902 as indicated in a state S1005, but the jet stream unevenness 1008 generated once does not vanish.

Note that FIG. 10 schematically expresses the jet stream unevenness 1008, and actually, the jet stream unevenness 1008 occurs in a certain range of region including immediately under the jet stream portion 205. The size of the region where the jet stream unevenness 1008 occurs varies depending on the speed of the jet stream and the size of the jet stream hole 902. Further, the jet stream unevenness 1008 is actually visually recognized after the completion of heating and drying and fixation of the ink on the recording medium 109. The liquid component remains at the stage of the state S1004, and hence the jet stream unevenness 1008 cannot be visually recognized.

According to the present Example, even when the interruption operation is thus performed during recording, it is possible to suppress the occurrence of jet stream unevenness. This will be described in detail below.

The recording apparatus 1 of the present Example performs recording by alternately repeating main scan and sub scan for conveying a prescribed conveyance amount of a recording medium. Then, when a predetermined interruption operation such as a wiping operation is performed between the first main scan and the subsequent second main scan, a prescribed conveyance amount of the recording medium is conveyed by a small conveyance operation including a first small conveyance operation by a conveyance unit and the subsequent second small conveyance operation. In other words, sub scan is performed by a plurality of small conveyance operations instead of performing sub scan by a prescribed conveyance amount of one conveyance operation. Then, the conveyance amount by the small conveyance operation is determined so that the position of the recording medium 109 stopping facing the jet stream hole 902 after the first small conveyance operation is performed may not be positioned at the position where the recording medium 109 stops facing the jet stream hole 902 after the second small conveyance operation is performed. The conveyance amount by the small conveyance operation is determined on the basis of the gap of the jet stream holes 902 in the second direction (Y direction). The conveyance amount by the small conveyance operation is smaller than the prescribed conveyance amount. The first small conveyance operation and the second small conveyance operation may be performed at an interval. One small conveyance operation is controlled by trapezoidal driving of an acceleration including constant acceleration, constant speed, and deceleration or S-shaped driving in which speed changes in trapezoidal driving are made smooth.

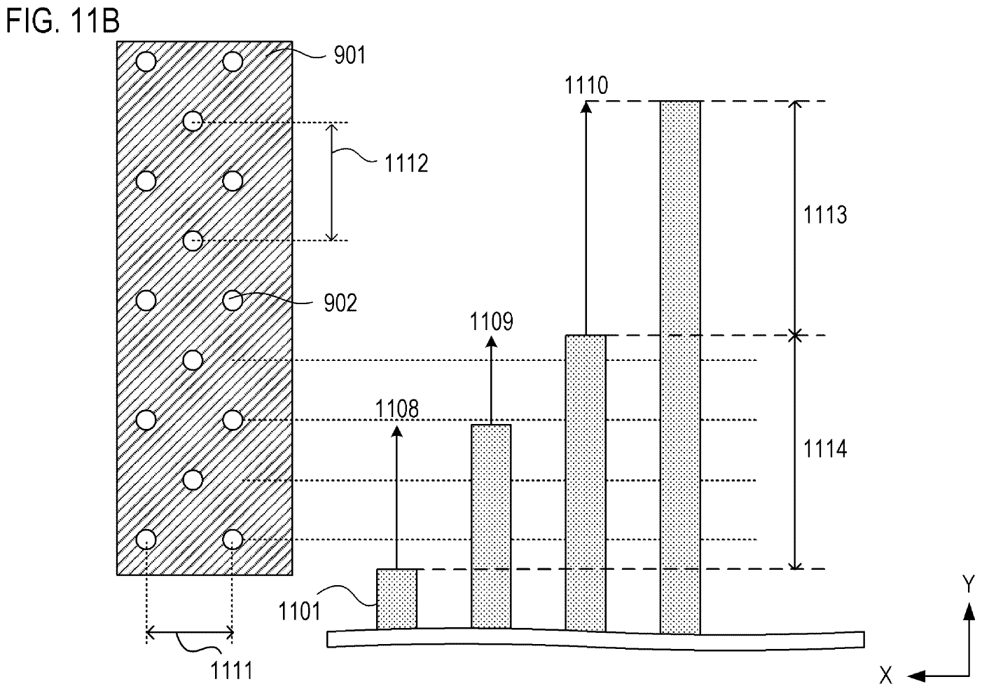

FIGS. 11A and 11B are diagrams for explaining the conveyance control at the time of the interruption operation in the present Example. The ink film 1101 ejected to the recording medium 109 enters the inside of the heating and drying mechanism 201 by the conveyance after ejection of the ink film 1101 as shown in a state S1102, and is located at the position of the parallel flow portion 207 and does not reach the jet stream portion 205. At the timing of a state S1102 where the ink film 1101 is recorded, a wiping operation by the maintenance mechanism 110 is interposed as an interruption operation.

With the normal conveyance control described previously with reference to FIG. 10, the recording medium 109 was conveyed to the position of the state S1104 for feeding the recording medium 109 for the next recording. In the conveyance control of the present Example shown in FIGS. 11A and 11n, the small conveyance operations are performed twice while carrying out the wiping operation, thereby moving the recording medium 109 to the position shown in states S1103 and S1104. The small conveyance operation is a conveyance operation with a conveyance amount less than a prescribed conveyance amount (recording scanning width). The total of the conveyance amounts by the two small conveyance operations is equal to the prescribed conveyance amount. Two small conveyance operations may be performed at an interval. Among the two small conveyance operations, the state in which the recording medium 109 stops after performing the first small conveyance operation 1108 is a state S1103, and the state in which the recording medium 109 stops after performing the second small conveyance operation 1109 is a state S1104. Subsequently, recording scanning and a conveyance operation of the recording scanning width indicated with an arrow 1110 are performed, and the recording medium 109 moves to the position shown by a state S1105.

The conveyance amount of the first small conveyance operation 1108 and the conveyance amount of the subsequent second small conveyance operation 1109 are determined as follows on the basis of the gap of the jet stream holes 902 in the second direction (the conveyance direction, or the Y direction). That is, determination thereof is achieved so that the position of the recording medium 109 that stops facing the jet stream hole 902 after performing the first small conveyance operation 1108 may not be positioned at the position where the recording medium 109 stops facing the jet stream hole 902 after the second small conveyance operation 1109 is performed. As a result of this, a region 1106 immediately under the jet stream hole 902 in the state S1103 and a region 1107 immediately under the jet stream hole 902 in the state S1104 are located at positions different from each other in the recording medium 109.

As a result of this, the region 1106 with which the jet stream collides in the state S1103 and the region 1107 with which the jet stream collides in the state S1104 do not overlap with each other. In this manner, the prescribed conveyance amount of the conveyance operation between the first main scan and the second main scan following the first main scan is divided in consideration of the pitch of the jet stream holes 902 so that the positions of the ink film 1101 and the jet stream holes 902 are shifted from each other. This shortens the time required for the same region in the ink film 1101 to stop immediately under the jet stream portion 205. As a result of this, the occurrence of jet stream unevenness can be suppressed. In the present Example, a wiping operation and two small conveyance operations shorter than the recording scanning width (the prescribed conveyance amount) are performed between the first main scan and the second main scan. When such a conveyance operation characteristic of the present Example is not performed, a wiping operation and one conveyance operation (sub scan) of the recording scanning width (the prescribed conveyance amount) are performed between the first main scan and the second main scan. In the present Example, when the interruption operation is performed, the number of the conveyance operations performed between the first main scan and the second main scan is only increased by one.

The conveyance amount of the small conveyance operation in the present Example will be described with reference to FIG. 11B. The number of the nozzles of the recording heads 101 and 102 of the present Example is 2,400 in the sub scanning direction (Y direction) at a density of 1200 dpi, and the size of the nozzle array in the sub scanning direction is approximately 50.8 mm. In order to carry out the four-division recording scan, the recording scan width is approximately 12.7 mm, and the amount of conveyance of the conveyance operation indicated with the arrow 1110 is the same as the recording scan widths 1113 and 1114. Also, as described in FIG. 9A, the pitch 1111 in the X direction of the jet stream holes 902 is 3.5 mm, so that the distance 1112 between the jet stream holes 902 in the conveyance direction (Y direction) is about 6.1 mm. The conveyance control is performed so that the total of the conveyance amount of the first small conveyance operation 1108 and the conveyance amount of the second small conveyance operation 1109 may become about 12.7 mm which is a prescribed conveyance amount (recording scanning width). In addition, the conveyance amount of each small conveyance operation is determined so that the part facing the jet stream hole 902 after the first small conveyance operation 1108 is performed may not be positioned at the position facing the jet stream hole 902 after the second small conveyance operation 1109 is performed. For example, the conveyance amount of the first small conveyance operation 1108 is set at 7.8 mm, and the conveyance amount of the second small conveyance operation 1109 is set at 4.9 mm. Incidentally, although the time required for the wiping operation is about 5 seconds, the present Example can be applied to, for example, 10 seconds longer than 5 seconds or 3 seconds that is shorter.

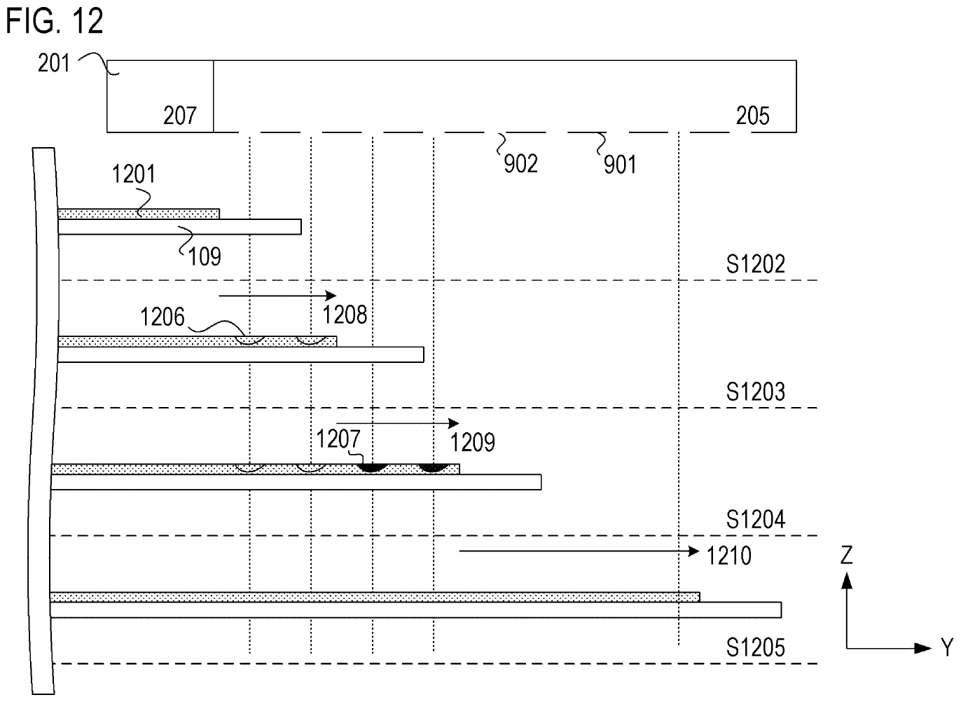

FIG. 12 is a diagram illustrating Comparative Example in which a small conveyance operation smaller than the recording scanning width is performed without considering the pitch of the jet stream holes 902 before and after the wiping operation. The ink film 1201 ejected to the recording medium 109 enters the inside of the heating and drying mechanism 201 by conveyance after ejection of the ink film 1201 as shown in a state S1202. At this timing, the wiping operation is performed. In Comparative Example of FIG. 12, two small conveyance operations 1208 and 1209 are performed while performing the wiping operation. The total of the conveyance amounts by the two small conveyance operations 1208 and 1209 is equal to the prescribed conveyance amount. Among the two small conveyance operations, the state in which the recording medium 109 stops after performing the first small conveyance operation 1208 is a state S1203, and the state in which the recording medium 109 stops after performing the second small conveyance operation 1209 is a state S1204. The two small conveyance operations 1208 and 1209 may be performed at an interval. Subsequently, recording scanning and a conveyance operation of the recording scanning width indicated with an arrow 1210 are performed, and the recording medium 109 moves to the position shown by a state S1205.

In Comparative Example shown in FIG. 12, a region 1206 of the recording medium 109 facing the jet stream hole 902 after the first small conveyance operation 1208 is performed and a region 1207 of the recording medium 109 facing the jet stream hole 902 after the second small conveyance operation 1209 is performed overlap with each other. Therefore, despite having performed the small conveyance operation twice, jet stream unevenness occurs in the region 1207.

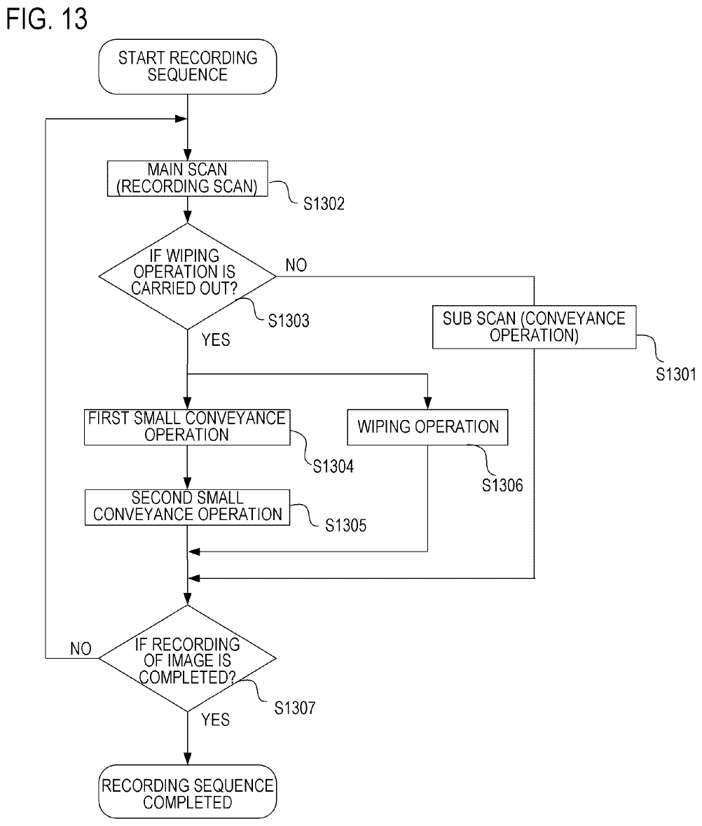

FIG. 13 is a flowchart illustrating conveyance control at the time of the interruption operation of the present Example. The processing shown in the flowchart is carried out by a CPU 608 of the recording control portion 607 of FIG. 6.

When the recording data is sent to the recording apparatus 1, in a step S1302, the CPU 608 performs recording scanning (main scan) by the recording heads 101 and 102. At the stage of completion of the main scan, in the S1303, the CPU 608 determines whether to perform a wiping operation.

When the wiping operation is not performed (step S1303: NO), the CPU 608 performs a conveyance process (sub scan) of the prescribed conveyance amount (recording scanning width) of the recording medium 109 by a conveyance motor 612 in a step S1301.

When the wiping operation is performed (step S1303: YES), the CPU 608 performs the first small conveyance operation of the step S1304 and the second small conveyance operation of the step S1305 to convey the recording medium 109 in a total predetermined conveyance amount. Further, the CPU 608 carries out the wiping operation of a step S1306 in parallel with the two small conveyance operations. The wiping operation in the step S1306 is the process described in FIG. 5.

Incidentally, the two small conveyance operations of the steps S1304 and S1305 and the wiping operation of the step S1306 may be performed in parallel, or the wiping operation (S1306) may be performed between the first small conveyance operation (S1304) and the second small conveyance operation (S1305). In the case where the first small conveyance operation, the wiping operation, and the second small conveyance operation are sequentially carried out, even when the conveyance motor 612 and the wiping operation motor 614 are the same motor, the conveyance control of the present Example can be performed by switching the gears.

After the completion of the sub scan of the step S1301, or after the completion of the small conveyance operation and the wiping operation of the steps S1304, S1305, and S1306, the CPU 608 determines whether recording of the image data has been completed in the S1307. When the recording has been completed (step S1307: YES), the CPU 608 finishes the recording sequence, and when the recording has not been completed (step S1307: NO), the CPU 608 returns to the step S1302.

As described up to this point, according to the present Example, with a recording apparatus having a drying device for drying the ink ejected onto a recording medium by using a collision jet stream, the occurrence of image unevenness can be suppressed when an interruption operation is performed during recording. When the recording operation has been stopped because of the interposition of an interruption operation such as a wiping operation, a small conveyance operation of the recording medium is performed a plurality of times with the conveyance amount determined in consideration of the pitch of the jet stream hole narrower than the recording scanning width therebefore and thereafter. This can suppress the occurrence of jet stream unevenness.

### Example 2

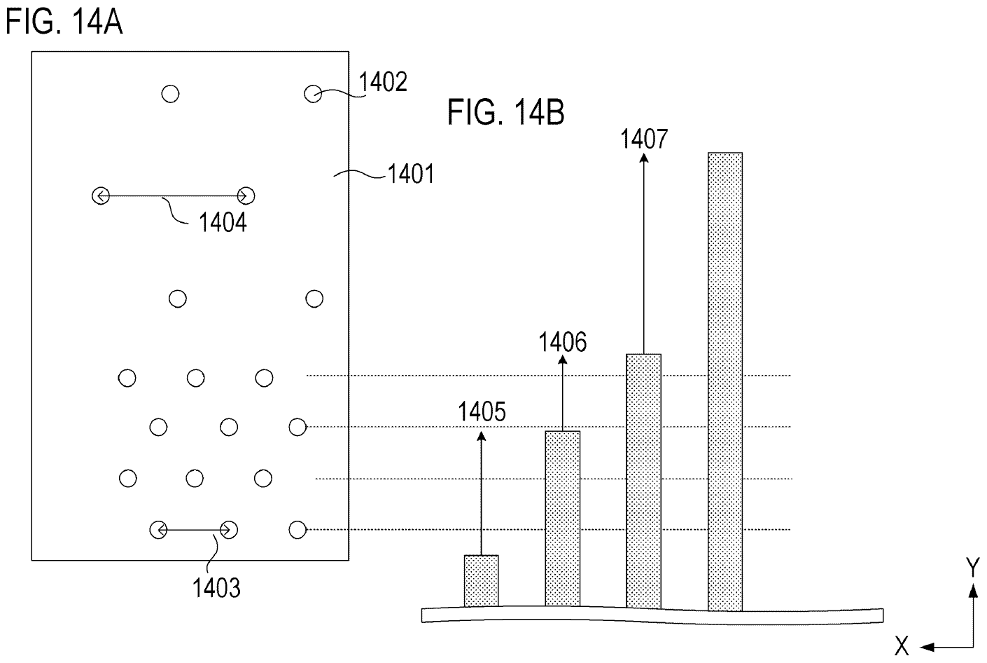

In Example 1, the case was described where the small conveyance operation performed at the time of the wiping operation was performed twice and the pitch of the jet stream holes 902 was a uniform pattern of 3.5 mm as shown in FIG. 11B. In Example 2, a description will be given to the case where the pitch of the jet stream holes in the jet stream portion 205 of the heating and drying mechanism 201 is changed between the upstream side (first half) and the downstream side (second half) in the Y direction (conveyance direction). FIG. 14A is a view showing the configuration of the jet stream portion 205 of the heating and drying mechanism 201 of Example 2. In the part of the jet stream portion 205 facing the recording medium 109, a jet stream hole 1402 is opened in the metal plate 1401. In the part on the upstream side in the Y direction, the pitch 1403 of the jet stream holes 1402 is 3.5 mm as in Example 1. In the part on the downstream side in the Y direction, the pitch 1404 of the jet stream holes 1402 is 7.0 mm.

FIG. 14B is a diagram for describing the conveyance control of Example 2. When a wiping operation as an interruption operation is performed between the first main scan and the subsequent second main scan, the first small conveyance operation 1405 and the second small conveyance operation 1406 are performed to perform a prescribed conveyance amount (recording scanning width) of conveyance. The conveyance amounts of the first small conveyance operation 1405 and the second small conveyance operation 1406 are the same as the conveyance amounts of the first small conveyance operation 1108 and the second small conveyance operation 1109 shown in FIGS. 11A and 11B of Example 1. The first small conveyance operation 1405 and the second small conveyance operation 1406 may be performed at an interval.

In drying using a collision jet stream, the larger the moisture content of the ink film is, the greater the effect of the difference in evaporation rate is exerted. For this reason, the conveyance amount of the small conveyance operation is determined on the basis of the pitch (3.5 mm) of the jet stream holes 1402 in the upstream side part. It should be noted that the conveyance amount of the small conveyance operation 1405 can be determined more easily when the arrangement of the jet stream holes 1402 in the region of the jet stream portion 205 where a jet stream is first sprayed onto the recording medium 109 (the upstream region) has a uniform pitch. However, unless the arrangement of the jet stream holes 1402 is at a uniform pitch, continuous application of the jet stream to the same site can be suppressed by properly devising the conveyance amount of the small carrying operation on the basis of the pitch of the jet stream holes 1402.

### Other Examples

In Examples 1 and 2, a description has been given to the case where the number of the small conveyance operations to be carried out at the time of the wiping operation is two. However, the operation may be divided into any number of operations so long as the total of the conveyance amounts of the small conveyance operations is equal to the prescribed conveyance amount (recording scanning width) and falls within a range falling within the time of the wiping operation.

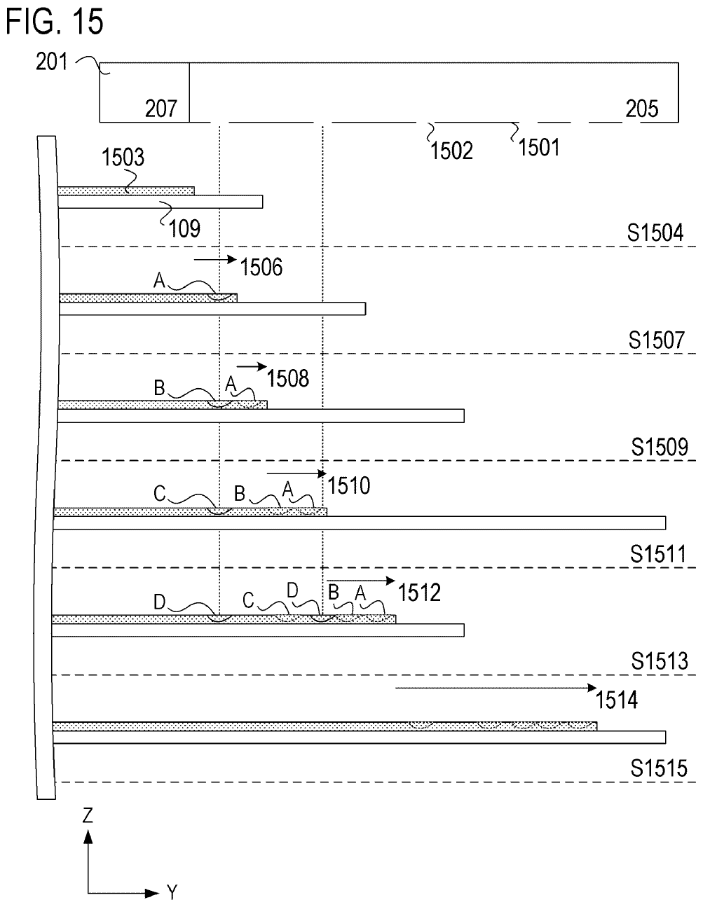

FIG. 15 shows an example of conveyance control in which four small conveyance operations are performed when an interruption operation such as a wiping operation is performed. The ink film 1503 ejected to the recording medium 109 enters the inside of the heating and drying mechanism 201 by the conveyance after the ejection of the ink film 1503, as shown in the state 1504, and is located at the position of the parallel flow portion 207 and does not reach the jet stream portion 205. At the timing of the state S1504 in which the ink film 1503 has been recorded, a wiping operation by the maintenance mechanism 110 is interposed as an interruption operation.

In the example of FIG. 15, four small conveyance operations 1506, 1508, 1510, and 1512 are performed while performing the wiping operation. As a result of this, the recording medium 109 moves at the positions shown in the states S1507, S1509, S1511, and S1513, respectively, and then stops. The total of the conveyance amounts by the four small conveyance operations is equal to the prescribed conveyance amount (recording scanning width). Subsequently, recording scanning and a conveyance operation of the recording scanning width indicated with an arrow 1514 are performed, and the recording medium 109 moves to the position shown by a state S1515.

The conveyance amount of each small conveyance operation is determined as follows. After the first small conveyance operation 1506 is performed, the site A of the recording medium 109 stopping facing the jet stream hole 1502 formed in the metal plate 1501 is not located at the site B of the recording medium 109 stopping facing the jet stream hole 1502 after performing the second small conveyance operation 1508. After the second small conveyance operation 1508 is performed, the sites A and B at which the recording medium 109 has stopped facing the jet stream hole 1502 are not located at the site C of the recording medium 109 that stops facing the jet stream hole 1502 after performing the third small conveyance operation 1510. After performing the third small conveyance operation 1510, sites A, B, and C at which the recording medium 109 has stopped facing the jet stream hole 1502 so far are not located at a site D at which the recording medium 109 stops facing the jet stream hole 1502 after performing the fourth small conveyance operation 1512.

In this manner, the small conveyance operation is performed by determining the conveyance amount, and the small conveyance operation is performed a plurality of times so that the sites at which the recording medium 109 stops immediately under the jet stream hole 1502 do not overlap each other. This can suppress the occurrence of jet stream unevenness.

It should be noted that an increase in the number of the small conveyance operations enables a more reduction of the possibility of the occurrence of jet stream unevenness. However, when the number of the small conveyance operations is too large, it becomes difficult to determine the conveyance amount of the small conveyance operation in consideration of the pitch of the jet stream hole. In the present Example, the amount of conveyance is determined so that regions slightly wider than the diameter of the jet stream hole may not overlap each other immediately under the jet stream hole. Incidentally, by determining the conveyance amount so that the regions having the same diameter as that of the jet stream hole may not overlap each other at least immediately under the jet stream holes, the jet stream unevenness can be suppressed.

The interruption operations (recovery operations) to be carried out during the recording operation include a suction operation in addition to the wiping operation to be carried out by the maintenance mechanism. However, the suction operation is required to have a longer stop time than that of the wiping operation. For example, it is assumed that the wiping operation takes 5 seconds and the suction operation takes 60 seconds. Assuming that the pitch of the jet stream holes is the same as that of Example 1 described with reference to FIG. 11B, 24 small conveyance operations are required to be performed in order to make the time during which the recording medium 109 is situated immediately under the jet stream hole equal to that in the case where the small conveyance operation has been performed twice in Example 1. In order to perform 24 small conveyance operations within a recording scanning width of 12.7 mm, the conveyance amount is 0.5 mm on average. Considering that the diameter of the jet stream hole is 1 mm, it can be said that it is difficult to determine the amount of conveyance in consideration of the pitch of the jet stream hole. For this reason, in the case of a long-time interruption operation such as a suction operation, even when sub scan is performed by being divided into a plurality of small conveyance operations during the interruption operation, as in the above-described Example, jet stream unevenness may occur.

Further, after the completion of the recording on the recording medium, drying and fixing of the ink film are performed, and also in this case, performing of the small conveyance operations before and after the wiping operation provides the effect of suppressing jet stream unevenness. Since it becomes unnecessary to consider the overlap of the dots for each recording scan, it is not necessary to match the total amount of the small conveyance operations with the recording scan width. However, it is desirable to carry out the same control as that before the completion of recording in consideration of the continuity of the control.

Further, in Example, an example using the recording head provided with a nozzle array of two columns of Even column and Odd column for one-color ink has been shown. However, a recording head further including nozzle arrays of a plurality of columns for one color may be used.

Also, the present disclosure is applicable to all recording apparatuses using recording media such as paper, fabric, non-woven fabric, and an OHP film, and the type of recording medium is not limited. It should be noted that, according to the present disclosure, it is possible to achieve both short-time ink drying using a collision jet stream and suppression of jet stream unevenness during an interruption operation. For this reason, the present disclosure can be particularly applied to the case where the recording medium does not absorb the liquid component of an ink, or has a characteristic of low-absorption properties. As specific applicable apparatuses, mention may be made of office machines such as printers, copiers, and facsimiles, mass production machines, industrial uses such as semiconductor devices, and the like.

Further, in the above-described Examples, a description has been given to the form in which the recording control portion 607 for performing the characteristic processing of the present disclosure is provided inside the inkjet recording apparatus. However, the recording control portion 607 is not required to be provided inside the inkjet recording apparatus. For example, the printer driver of the host computer (image input portion 602) to be connected to the inkjet recording apparatus may have the function of the recording control portion 607. In this way, an inkjet recording system configured by including the host computer and the inkjet recording apparatus is also in the category of the present disclosure. In this case, the host computer functions as a data supply device for supplying data to the inkjet recording apparatus, and also functions as a control device for controlling the inkjet recording apparatus.

According to the present disclosure, with a recording apparatus having a drying device that dries the ink ejected to a recording medium using a collision jet stream, the occurrence of image unevenness can be suppressed when an interruption operation is performed during recording.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-146371, filed on Aug. 28, 2024, which is hereby incorporated by reference herein in its entirety.

What is claimed is:

1. A recording apparatus comprising:
a recording head for ejecting ink while moving relative to a recording medium in a first direction;
a conveyance unit for conveying the recording medium in a second direction that intersects the first direction;
a drying unit having a plurality of air outlet ports arranged in the second direction, the drying unit spraying a jet stream of a gas from the air outlet ports toward a surface of the recording medium on which the ink has been ejected; and
a control unit for alternately performing main scan in which the recording head ejects the ink onto the recording medium and sub scan in which the conveyance unit conveys a prescribed conveyance amount of the recording medium,
wherein in a case where a predetermined interruption operation is performed between first main scan and subsequent second main scan, the control unit conveys the prescribed conveyance amount of the recording medium by a small conveyance operation including a first small conveyance operation and a subsequent second small conveyance operation by the conveyance unit, and
wherein conveyance amounts of the first small conveyance operation and the second small conveyance operation are determined on the basis of gaps in the second direction of the plurality of air outlet ports so that a part of the recording medium facing the air outlet port after performing the first small conveyance operation may not be positioned at a position facing the air outlet port after performing the second small conveyance operation.

2. The recording apparatus according to claim 1,
wherein the control unit performs the first small conveyance operation and the second small conveyance operation at an interval.

3. The recording apparatus according to claim 1,
wherein the conveyance amounts of the first small conveyance operation and the second small conveyance operation are determined so that a part of the recording medium that stops facing the air outlet port after performing the first small conveyance operation may not be positioned at a position where the recording medium stops facing the air outlet port after performing the second small conveyance operation.

4. The recording apparatus according to claim 1,
wherein the small conveyance operation is performed in parallel with the interruption operation.

5. The recording apparatus according to claim 1,
wherein the interruption operation is performed between the first small conveyance operation and the second small conveyance operation.

6. The recording apparatus according to claim 1,
wherein the interruption operation is a wiping operation for wiping an ejection surface provided with a nozzle of the recording head.

7. The recording apparatus according to claim 1,
wherein the interruption operation is a suction operation for sucking a nozzle of the recording head.

8. The recording apparatus according to claim 1,
wherein the interruption operation is a preliminary ejection operation for performing preliminary ink ejection from the recording head.

9. The recording apparatus according to claim 1,
wherein the recording head ejects a plurality of inks, the plurality of inks including a color ink containing a color material, and a reaction solution containing a component that insolubilizes or aggregates the color material of the color ink.

10. The recording apparatus according to claim 1,
wherein the recording medium has a characteristic of not absorbing a liquid component of the ink.

11. The recording apparatus according to claim 1,
wherein the drying unit has a jet stream portion provided with the air outlet port, and a parallel flow portion provided on an upstream side of the jet stream portion in the second direction and allowing a gas to flow along a surface of the recording medium on which the ink of the recording medium has been ejected.

12. A method for recording an image by a recording apparatus,
the recording apparatus comprising:
a recording head for ejecting an ink while moving relative to a recording medium in a first direction;
a conveyance unit for conveying the recording medium in a second direction that intersects the first direction; and
a drying unit having a plurality of air outlet ports arranged in the second direction, the drying unit spraying a jet stream of a gas from the air outlet ports toward a surface of the recording medium on which the ink has been ejected;
wherein with the recording method, an image is recorded on the recording medium by alternately performing main scan for ejecting the ink to the recording medium by the recording head and sub scan for conveying a prescribed conveyance amount of the recording medium by the conveyance unit,
wherein the recording method comprises the steps of:
performing a predetermined interruption operation between first main scan and subsequent second main scan; and
conveying the prescribed transport amount of the recording medium by a small conveyance operation including a first small conveyance operation and a subsequent second small conveyance operation by the conveyance unit in a case where the interruption operation is performed; and
wherein conveyance amounts of the first small conveyance operation and the second small conveyance operation are determined on the basis of gaps in the second direction of the plurality of air outlet ports so that a part of the recording medium facing the air outlet port after performing the first small conveyance operation may not be positioned at a position facing the air outlet port after performing the second small conveyance operation.
